(19) United States
(12) Patent Application Publication
(10) Pub. No.: US 2016/0316038 A1
(43) Pub. Date: Oct. 27, 2016

(54) SHARED MEMORY MESSAGING CHANNEL BROKER FOR AN APPLICATION SERVER

(71) Applicant: Masoud Aghadavoodi Jolfaei, Wiesloch (DE)

(72) Inventor: Masoud Aghadavoodi Jolfaei, Wiesloch (DE)

(21) Appl. No.: 14/691,829

(22) Filed: Apr. 21, 2015

(51) Int. Cl. H04L 29/08

(52) U.S. Cl. CPC H04L 67/2842; H04L 67/1002

(57) ABSTRACT

According to some embodiments, a shared memory messaging channel broker of a database application server may receive a first subscription request from a first application session. The first subscription request may be, for example, associated with a first shared memory entity. It may be automatically determined that the first shared memory entity has been updated, and, responsive to this determination, a notification associated with the update may be automatically transmitted to the first application session.

### BACKGROUND

An application server may let multiple users and/or application session access information in a database simultaneously. For example, a user might access a Grapical User Interface (“GUI”) that displays purchase order information from the database in substantially real time. In some cases, the application server might use a shared memory portion to locally store information (e.g., an object or table) and improve performance. For example, a shared memory infrastructure, such as in an Advanced Business Application Programming (“ABAP”) engine, may be used to cache and/or buffer ABAP entities (e.g., structures, tables, and/or objects) at the application server to speed up the read-access for those entities from an ABAP session residing on the application server. Note that a number of applications may exist that use shared memory entities to exchange data. Moreover, these applications may run on the same or different servers and try to synchronize their content, such as master data, material data, or order entries.

However, an application that has retrieved information from the shared memory infrastructure may be unaware when the information is subsequently updated by another application. That is, the typical exchange of shared memory between different applications is generally based on a kind of “push-and-pull” mechanism. Because the content of shared memory entities can change at any time, and the determined and displayed data based on those entities may be altered frequently, issues may arise wherein both calculated business data and applied functions by end-users to that data (e.g., calculating a total for certain data) are not up-to-date and do not reflect the current data. In an attempt to solve this problem, the affected shared memory entries may be rechecked/re-read frequently. This, however, can lead to increased shared memory and application server access times and loads.

In addition to data inconsistency scenarios, such a limitation may result in an inability to implement new business use-cases (e.g., to display the latest business information on a screen or to initiate a subsequent process or workflow). As a result, improved systems and methods to accuratelly and efficiently access shared memory entities in an application server may be desired.

### BRIEF DESCRIPTION OF THE DRAWINGS

FIG. 1 is a block diagram of a system according to some embodiments.

FIG. 2 is a flow diagram of a process according to some embodiments.

FIGS. 3 through 5 illustrate a timeline associated with a simple shared memory messaging channel interaction model.

FIG. 6 is a block diagram of an apparatus according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

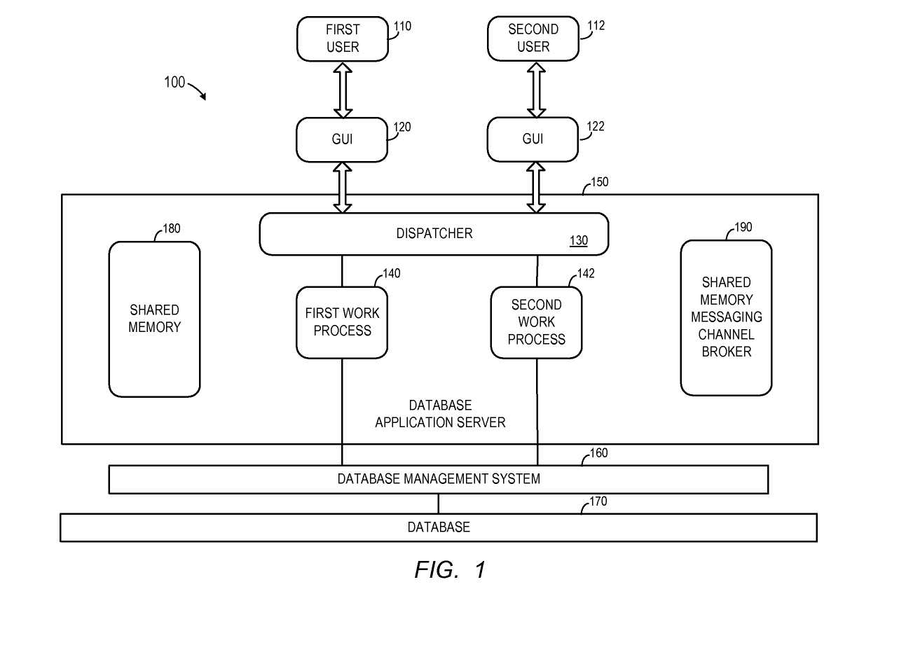

FIG. 1 is a block diagram of system 100 according to some embodiments. The system 100 includes a database application server 150 that may access information in a database 170 via a database management system 160. A first user 110 may access the application server 150 via a first Graphical User Interface (“GUI”) 120. In particular, a dispatcher 130 in the application server 150 may establish a first work process 140 or session for the first user 110. Similarly, a second user 112 may access the application server 150 via a second GUI 122 (and the dispatcher 130 may establish a second work process 142 or session for the second user 112. To improve performance of the system 100, some information may be locally stored in shared memory 180 at the application server 150. According to some embodiments, the system 100 supports multi-tenancy to separately support multiple unrelated clients by providing multiple logical database systems which are programmatically isolated from one another. Moreover, in some embodiments the system may implement an “in-memory” database, in which data is a full database stored in volatile (e.g., non-disk-based) memory (e.g., Random Access Memory). The full database may be persisted in and/or backed up to fixed disks (not shown). Embodiments are not limited to an in-memory implementation. For example, some data might be stored in Random Access Memory (e.g., cache memory for storing recently-used data) and one or more fixed disks (e.g., persistent memory for storing their respective portions of the full database).

The system 100 may be associated with any query-responsive data source or sources that are or become known, including but not limited to a Structured-Query Language (“SQL”) relational database management system. The system may also be associated with a relational database, a multi-dimensional database, an eXtendable Markup Language (“XML”) document, or any other data storage system storing structured and/or unstructured data. Note that in some embodiments, the system 100 may be distributed among several relational databases, dimensional databases, and/or other data sources. Embodiments are not limited to any number or types of data sources.

Presentation of information to the users 110, 112 may comprise any degree or type of rendering. For example, the system 100 may execute a Web browser to receive a Web page (e.g., in HTML format) from a data server, and may render and present the Web page according to known protocols. The system 100 may also or alternatively present user interfaces by executing a standalone executable file (e.g., an .exe file) or code (e.g., a JAVA applet) within a virtual machine. Note that the system 100 may include any number of clients of one or more types according to some embodiments.

There are a large number of applications that may use the share memory 180, i.e. via export and import ABAP entities to the shared memory 180, or shared objects, to exchange information and to synchronize content. This category includes applications that need fast access to the application server 150 based cache containing entities, i.e., structures, tables, and/or objects. This type of fast access cache may be implemented via the shared memory 180 or shared objects infrastructure.

The typical exchange of shared memory 180 content between different applications, which may even reside on different application servers 150, is usually based on a kind of “push-and-pull” mechanism Because the content of shared memory entities can change at any time, and the determined and displayed data based on those entities may be altered frequently, issues may arise wherein both calculated business data and applied functions by end-users to that data (e.g., calculating a total for certain data) are not up-to-date and do not reflect the current data. In an attempt to solve this problem, the affected shared memory entries may be rechecked/re-read frequently. This, however, can lead to increased shared memory and application server access times and loads.

Further, known infrastructures based on re-checking (using repeated checks) of the status and/or value of the shared memory entities (like shared objects) may establish a status based on a time stamp and/or a version number. As soon as changes are detected, the ABAP messaging channel could be used to notify the sessions and subscribers to the event. With this strategy, the session and application will not get an active notification from shared memory, which still leads to outdated data in a session depending on the frequency of the repeated checks of the shared memory access. This also leads to unnecessary increased consumption of system resources (e.g., network traffic in case of an access to a distributed file system or application server). Note that the total cost of ownership for a polling technology may be much higher as compared to an event-driven technology.

To avoid such a result, some embodiments described herein may include a shared memory messaging channel broker 190 for the database application server. Note that it may be desirable to only re-read the shared memory 180 data when the affected shared memory 180 entities have been modified. Embodiments may provide an event-driven solution, in ABAP, to subscribe to actions, i.e., create, update, and/or delete actions, that are applied to the shared memory 180 entities. According to some embodiment, “shared memory messaging channels” may be provided. In this case, applications may be able to subscribe to future changes that are applied to any shared memory 180 entity. According to some embodiments, each shared memory entity is associated with a channel, e.g., a shared memory entity for “orders” or “catalogs” may assigned to a channel named “/orders” or “/catalogs.” When any action, update, or change occurs to this entity, an event and message with the appropriate meta-data information (e.g., the name of the entity and the applied action) may be transmitted to the sessions that are subscribed to the channel (such as “/catalogs”). After receiving this message, the application can either trigger further actions to process the shared memory 180 entity or trigger an event (such as via an ABAP push channel or a GUI push channel) to display to the end-user 110, 112 the altered status of the affected UI elements (that is, the displayed content from shared memory 180 entity). The changes to a shared memory 180 entity may also lead to changes to the database entities which are in use in different processes, sessions and/or UI elements. Using ABAP channels, some embodiments may combine the shared memory messaging channels with the database messaging channels, the ABAP push channel, the ABAP messaging channel and/or the GUI push channel to expose the shared memory 180 changes to other event technologies in ABAP. Moreover, embodiments may pipe and/or forward the event to other event channels that are subscribed and consumed in session or user interfaces.

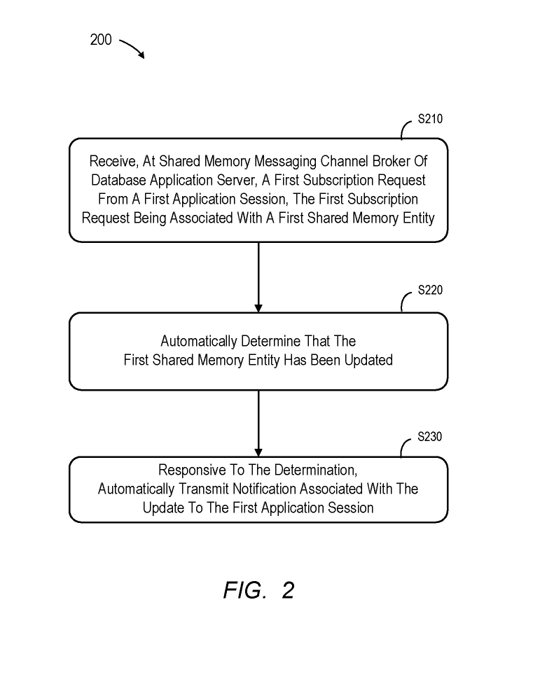

FIG. 2 comprises a flow diagram of process 200 according to some embodiments. In some embodiments, various hardware elements of the system 100 of FIG. 1 (e.g., one or more processors) execute program code to perform the process 200. The process 200 and all other processes mentioned herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software. Moreover, steps of the process may be performed in any order that is practical.

Initially, at S210, a shared memory messaging channel broker of a database application server (e.g., an ABAP application server) may receive a first subscription request from a first application session. The first subscription request may be associated with, for example, a first shared memory entity. The first shared memory entity might be associated with, for example, a shared object area, a shared structure, and/or a shared table.

At S220, it may be “automatically” determined that the first shared memory entity has been updated. As used herein, the term “automatically” may refer to an action that is taken with little or no human intervention. The update might be associated with, for example, a read event, a write event, an update event, and/or a delete event. Responsive to the determination at S220, a notification associated with the update may be automatically transmitted to the first application session at S230. According to some embodiments, the notification includes metadata such as a name of the first shared memory entity and/or an action associated with the update.

Note that the process 200 of FIG. 2 may support multiple application sessions. For example, a second subscription request may be received from a second application session, and the second subscription request being associated with the first shared memory entity. In this case, responsive to the determination at S220, automatically transmit a notification associated with the update to the second application session. Further note that at least one of the first and second application sessions may be associated with a GUI application session or a web browser application session. Moreover, the first and second application sessions may comprise, according to some embodiments, different sessions of the same application executing in parallel.

The process 200 of FIG. 2 may also support multiple subscriptions by a single application session. For example, a second subscription request may be received from the first application session, the second subscription request being associated with a second shared memory entity. In this case, it may be automatically determined that the second shared memory entity has been updated, and, responsive to this determination, a notification associated with the update may be automatically transmitted to the first application session.

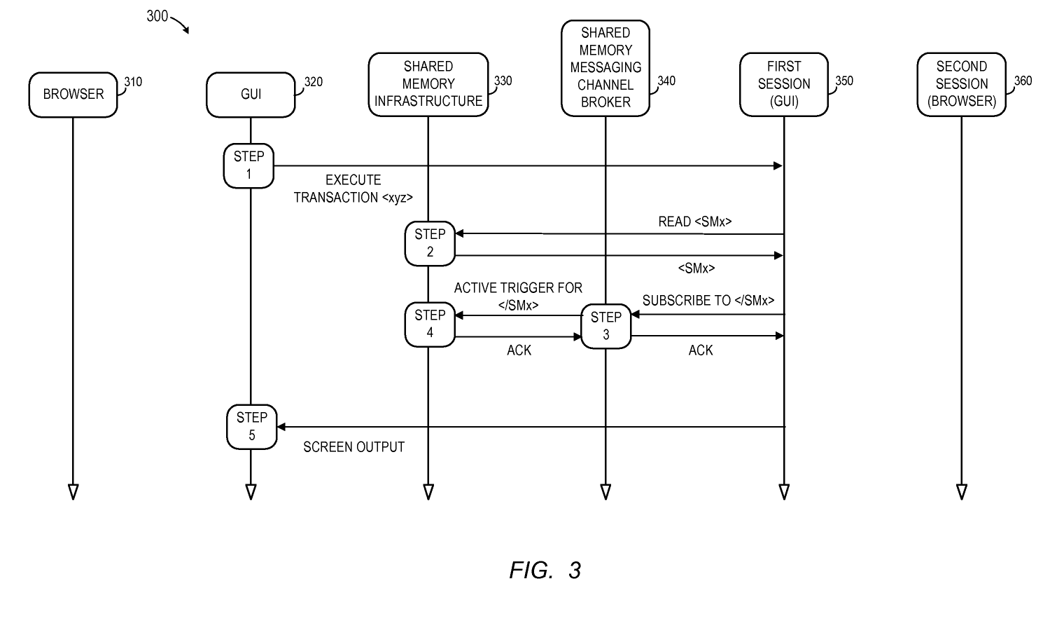

FIGS. 3 through 5 illustrate a timeline associated with a simple interaction model in accordance with some embodiments. In particular, applications are running in parallel and a change is applied to a shared memory entity (such as a shared object area). The updated shared memory entity may be used, for example, to calculate business content and additionally to represent the results in respective user agent technology.

Referring now to FIG. 3, a timeline 300 includes two active applications: a Web Dynpro Browser 310 and a GUI 320 (such as a reach user agent for an SAP NetWeaver ABAP engine). Each user agent, that is the browser 310 and GUI 320 are associated with a dedicated ABAP session 360, 350 (containing the appropriate application context). Both applications 310, 320 will eventually execute a business transaction which accesses the same shared memory entity: the shared memory/object <SMx>.

At step 1, the GUI 320 executes transaction <xyz> for the first session 350. As a result, the first session 350 reads <SMx> from a shared memory infrastructure 330 at step 2. Moreover, the first session 350 indicates to a shared memory messaging channel broker 340 that it wants to subscribe to channel </SMx> at step 3, and the shared memory messaging channel broker 340 establishes an active trigger for channel </SMx>at step 4. Note that an affirmative acknowledgement may be returned for both steps 3 and 4. The <SMx> that was read at step 2 may then be used by the first session 350 to create screen output for the GUI 320 at step 5 (showing the business data containing the content <SMx>).

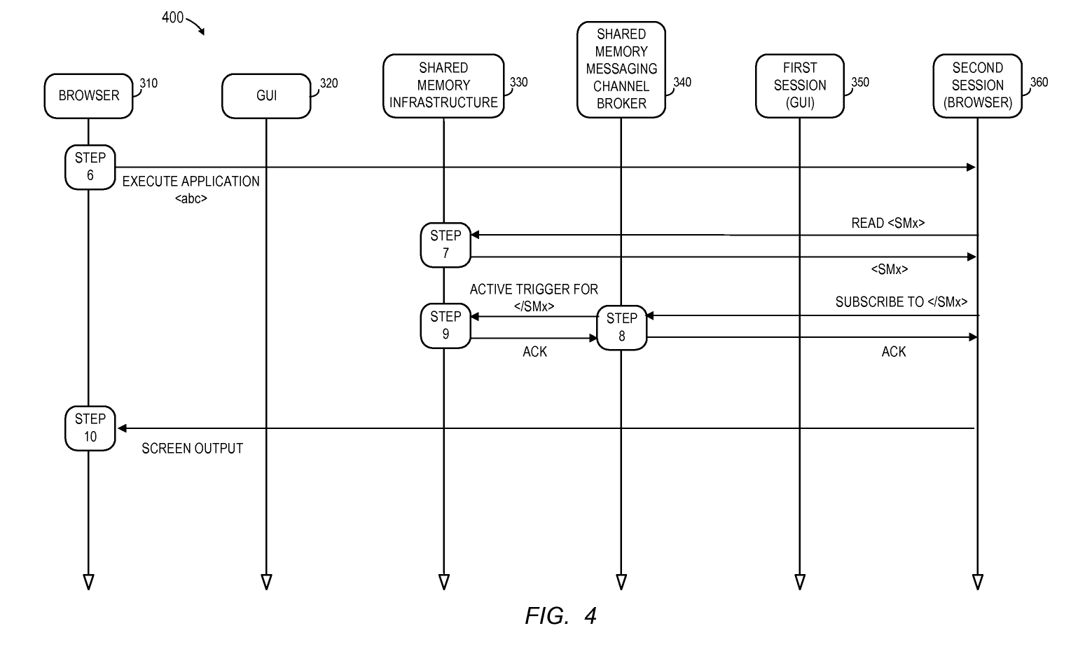

Referring now to FIG. 4, a similar timeline 400 may be provided for the browser 310 and the second session 360. At step 6, the browser 310 executes application <abc> for the second session 360. As a result, the second session 360 reads <SMx> from the shared memory infrastructure 330 at step 7. Moreover, the second session 360 indicates to the shared memory messaging channel broker 340 that it also wants to subscribe to channel </SMx> at step 8, and the shared memory messaging channel broker 340 establishes an active trigger for channel </SMx>at step 9. Note that an affirmative acknowledgement may be returned for both steps 8 and 9. The <SMx> that was read at step 7 may then be used by the second session 360 to create screen output for the browser 310 at step 10 (showing the business data containing the content <SMx>).

That is, in steps 1 through 5 during execution of the GUI transaction, the content of the shared memory entity <SMx> is read the same shared memory that is then accessed by the browser application in steps 6 through 10. In both cases, the shared memory entity <SMx> is read and either part or the complete shared memory entity <SMx> is accessed in the associated session. In steps 3 and 8, each application subscribed to the shared memory messaging channel “</SMx>” in order to receive notification from the framework as soon as any change is applied to the shared memory entity <SMx>.

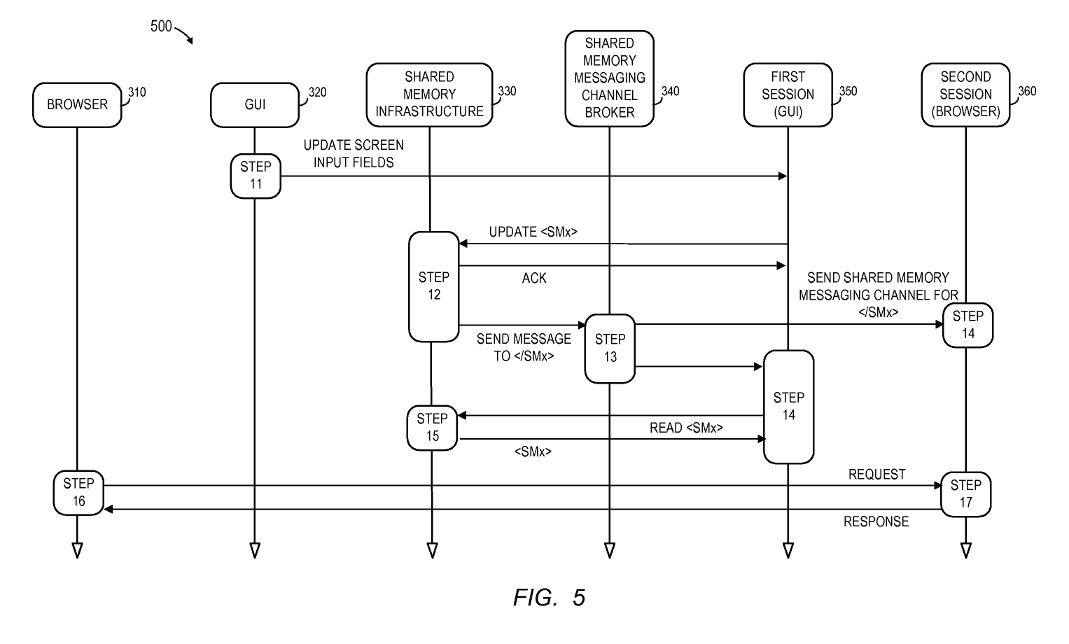

Based on the underlying business logic and the represented screen, the end user may be able to update screen elements (such as, for example, by placing an order), that will leads to an update to the shared memory entity <SMx>. For example, referring now to FIG. 5, a timeline 500 shows at step 11 that the user of the GUI 320 provided an update to screen input fields to the first session 350. As a result, the first session 350 updates <SMx> to the shared memory infrastructure 330 at step 12 (and an acknowledgement is returned). Because of the automatic triggers that were established in FIGS. 3 and 4, at step 12 a message is automatically provided to the shared memory messaging channel broker 340. Moreover, the shared memory messaging channel broker 340 automatically transmits a shared memory messaging channel notification for channel </SMx> to first session 350 and the second session 360 at steps 13 and 14. The first session 350 can then read <SMx> from the shared memory infrastructure 330 at steps 14 and 15. Because it received a notification, the second session 360 can also update the browser 310 screen with the newly changed business data via a request and response at step 16. Alternatively, with the help of the ABAP Push Channel or SAPGUI Push Channel, the shared memory notification might be immediately transmitted to the affected GUIs (i.e., SAPGUI or browser-based UI). Additionally, this notification may be displayed in screen as a notification bar to the end user. The user might, according to some embodiments, trigger a request to retrieve the new information from the backend (from the shared memory area) and to update the screen with the latest information.

Beside the scenario of FIGS. 3 through 5, a similar scenario may exist with ABAP applications, e.g., monitoring, administration and/or security applications, that access shared memory areas. In this case, a real-time notification to the applications that are subscribed to the shared memory messaging channels may be utilized. Moreover, according to some embodiments, with a GUI push channel and ABAP push channel even the transfer of the shared memory change events to the user agents (a GUI or HTML5 browser based application) may be realized. For example, an automatic refresh of the updated UI elements may be provided (showing, for example, pure shared memory content in concurrent administrative and/or monitoring screens).

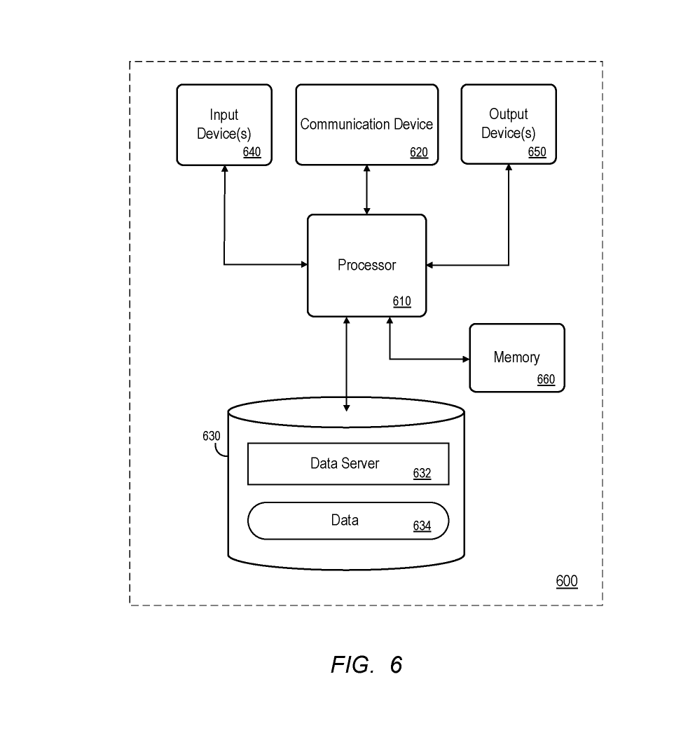

FIG. 6 is a block diagram of apparatus 600 according to some embodiments. The apparatus 600 may comprise a general-purpose computing device and may execute program code to perform any of the functions described herein. The apparatus 600 may comprise an implementation of a database application server in accordance with any of the embodiments described herein. The apparatus 600 may include other unshown elements according to some embodiments.

The apparatus 600 includes a processor 610 operatively coupled to a communication device 620, a data storage device 630, one or more input devices 640, one or more output devices 650, and a memory 660. The communication device 620 may facilitate communication with external devices, such as a reporting client, or a data storage device. The input device(s) 640 may comprise, for example, a keyboard, a keypad, a mouse or other pointing device, a microphone, knob or a switch, an Infra-Red (“IR”) port, a docking station, and/or a touch screen. The input device(s) 640 may be used, for example, to enter information into apparatus 600. The output device(s) 650 may comprise, for example, a display (e.g., a display screen), a speaker, and/or a printer.

The data storage device 630 may comprise any appropriate persistent storage device, including combinations of magnetic storage devices (e.g., magnetic tape, hard disk drives and flash memory), optical storage devices, Read Only Memory (ROM) devices, etc., while the memory 660 may comprise Random Access Memory (RAM).

The data server 632 may comprise program code executed by the processor 610 to cause the apparatus 600 to perform any one or more of the processes described herein. Note that embodiments are not limited to execution of these processes by a single apparatus. The data 634 may include database data and shared memory objects as described herein. As also described herein, such database data (either cached or a full database) and/or shared memory objects may be stored in volatile memory such as the memory 660. The data storage device 630 may also store data and other program code for providing additional functionality and/or which are necessary for operation of the apparatus 600, such as device drivers, operating system files, etc.

Thus, some embodiments may provide a “shared memory messaging channel” is such that a transfer of events and messages from a shared memory infrastructure may be transmitted to sessions or user-agents based on a “publish-subscribe” model. Each shared memory entity may be associated with a channel similar to ABAP messaging channels, e.g., a shared object area “sales_order_entry” may be assigned to a channel named “/sales_order_entry.” As soon as any action is applied to the shared memory entity (e.g., read, write, update, or delete) an event and message with the appropriate meta-data information (e.g., the name of the entity and the applied action) may be transmitted to the sessions or user-agent that are subscribed to that channel.

To achieve this goal, three steps may be taken:

1) For each shared memory entity (e.g., shared object area), a dedicated “shared memory messaging channel” may be defined. For example, changes to the entity “master_data” may be associated with a channel named “/master_data.” The subscription and publication may take place based on the defined “shared memory messaging channel.” Thus, each application can subscribe to Create, Read, Update, Delete (“CRUD”) activities on a specific shared memory entity “master_data” and to its associated shared memory messaging channel (“/master data”).

2) In the shared memory infrastructure, a registration for access (create, read, update, delete) notification to the shared memory entity (“master_data) is established. After successful registration, a message including meta-data, (the applied actions (create, read, update, delete) and the name of the entities) may be sent to the shared memory messaging channel broker.

3) Finally, the shared memory messaging channel broker may forward messages to the subscribers of the shared memory messaging channel (such as the sessions or user-agents who are subscribed to channel “/master data”).

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A database application server, comprising:
a shared memory portion, the shared memory portion including shared memory entities; and
a shared memory messaging channel broker to:
receive a first subscription request from a first application session, the first subscription request being associated with a first shared memory entity,
automatically determine that the first shared memory entity has been updated,
responsive to said determination, automatically transmit a notification associated with the update to the first application session.

2. The database application server of claim 1, wherein the database application server comprises an advanced business application programming application server.

3. The database application server of claim 1, wherein the shared memory messaging channel broker is further to:
receive a second subscription request from a second application session, the second subscription request being associated with the first shared memory entity, and
responsive to said determination, automatically transmit a notification associated with the update to the second application session.

4. The database application server of claim 3, wherein at least one of the first and second application sessions is associated with a graphical user interface application session or a web browser application session.

5. The database application server of claim 3, wherein the first and second application sessions are different sessions of the same application executing in parallel.

6. The database application server of claim 1, wherein the shared memory messaging channel broker is further to:
receive a second subscription request from the first application session, the second subscription request being associated with a second shared memory entity,
automatically determine that the second shared memory entity has been updated, and
responsive to said determination, automatically transmit a notification associated with the update to the first application session.

7. The database application server of claim 1, wherein the first shared memory entity is associated with at least one of: (i) a shared object area, (ii) a shared structure, and (iii) a shared table.

8. The database application server of claim 1, wherein the update comprises at least one of: (i) a read event, (ii) a write event, (iii) an update event, and (iv) a delete event.

9. The database application server of claim 1, wherein the notification includes metadata comprising a name of the first shared memory entity and an action associated with the update.

10. A computer-implemented method, comprising:
receiving, at a shared memory messaging channel broker of a database application server, a first subscription request from a first application session, the first subscription request being associated with a first shared memory entity;
automatically determining that the first shared memory entity has been updated; and
responsive to said determination, automatically transmitting a notification associated with the update to the first application session.

11. The method of claim 10, wherein the database application server comprises an advanced business application programming application server.

12. The method of claim 10, further comprising:
receiving a second subscription request from a second application session, the second subscription request being associated with the first shared memory entity; and
responsive to said determination, automatically transmitting a notification associated with the update to the second application session.

13. The method of claim 12, wherein at least one of the first and second application sessions is associated with a graphical user interface application session or a web browser application session.

14. The method of claim 12, wherein the first and second application sessions are different sessions of the same application executing in parallel.

15. The method of claim 10, further comprising:
receiving a second subscription request from the first application session, the second subscription request being associated with a second shared memory entity;
automatically determining that the second shared memory entity has been updated; and
responsive to said determination, automatically transmitting a notification associated with the update to the first application session.

16. The method of claim 10, wherein the first shared memory entity is associated with at least one of: (i) a shared object area, (ii) a shared structure, and (iii) a shared table.

17. The method of claim 10, wherein the update comprises at least one of: (i) a read event, (ii) a write event, (iii) an update event, and (iv) a delete event.

18. The database application server of claim 10, wherein the notification includes metadata comprising a name of the first shared memory entity and an action associated with the update.

19. A non-transitory computer-readable medium storing program code, the program code executable by a computer system to cause to the computer system to:
receiving, at a shared memory messaging channel broker of an advanced business application programming application server, a first subscription request from a first application session, the first subscription request being associated with a first shared memory entity;
receiving a second subscription request from a second application session, the second subscription request being associated with the first shared memory entity;
automatically determining that the first shared memory entity has been updated, wherein the update comprises at least one of: (i) a read event, (ii) a write event, (iii) an update event, and (iv) a delete event;
responsive to said determination, automatically transmitting a notification associated with the update to the first application session and the second application session, wherein the notification includes metadata comprising a name of the first shared memory entity and an action associated with the update.

20. The medium of claim 19, wherein at least one of the first and second application sessions is associated with a graphical user interface application session or a web browser application session.

21. The medium of claim 19, wherein the first and second application sessions are different sessions of the same application executing in parallel.
